(19) United States
(12) Patent Application Publication
(10) Pub. No.: US 2020/0043360 A1
(43) Pub. Date: Feb. 6, 2020

(54) ACTION SUPPORT DEVICE AND ACTION SUPPORT METHOD

(71) Applicant: Hitachi, Ltd., Tokyo (JP)

(72) Inventors: Yasuhiro ASA, Tokyo (JP); Hiroki SATO, Tokyo (JP); Takashi NUMATA, Tokyo (JP)

(21) Appl. No.: 16/434,193

(22) Filed: Jun. 7, 2019

(30) Foreign Application Priority Data
Jul. 31, 2018 (JP) 2018-144398

(51) Int. Cl. G09B 19/00

(52) U.S. Cl. CPC G09B 19/00

(57) ABSTRACT

An action support device stores correspondence information in which an action and a feeling of a subject and an expression of a face are associated with respect to each of a series of tasks set in order, and performs a specification process in which a feeling of the subject is specified on the basis of the information related to an expression of the subject acquired by an acquisition device, an evaluation process in which an action related to the task of the subject is evaluated on the basis of the information related to a behavior of the subject, a selection process in which an expression of the face image is selected with reference to the correspondence information on the basis of the feeling of the subject and an evaluation result of the evaluation process, in which the face image of the expression selected by the selection process is output.

### CLAIM OF PRIORITY

The present application claims priority from Japanese patent application JP 2018-144398 filed on Jul. 31, 2018, the content of which is hereby incorporated by reference into this application.

### BACKGROUND OF THE INVENTION

### 1. Field of the Invention

The present invention relates to an action support device and an action support method which supports an action of a subject.

### 2. Description of the Related Art

JP 2005-258820 A discloses a feeling inducing device in which an agent performs an influential communication with a person even in a state where a mental state of the person is negative. The feeling inducing device includes a mental detection unit which detects a mental situation of a person using at least one of a bio-information detection sensor and a human-state detection sensor, a situation detection unit which detects a situation where a person is, and a mental state determination unit which determines whether the mental state of the person is in a state of feeling unpleasant on the basis of the mental situation of the person detected by the mental detection unit, the situation where the person is which is detected by the situation detection unit, and a continuing time of the situation. In a case where the mental state determination unit determines that the mental state of the person is in a state of feeling unpleasant, the agent communicates with the person in sympathy with the mental state.

### SUMMARY OF THE INVENTION

However, in the related art described above, there is no configuration to induce the subject to execute the task for each segmentalized task. Therefore, the expression of the agent is not selected depending on whether the action of each task is successful. For this reason, the subject may be not urged to do a target action.

An object of the invention is to effectively motivate the subject.

There are provided an action support device and an action support method according to an aspect of the invention disclosed in this application. The action support device includes a processor which performs a program, a memory device which stores the program, an acquisition device which acquires information related to a subject, and an output device which outputs information to the subject. The memory device stores correspondence information in which an action and a feeling of the subject and an expression of a face image output from the output device are associated with respect to each of a series of tasks set in order. The processor performs a specification process in which a feeling of the subject is specified on the basis of the information related to an expression of the subject acquired by the acquisition device, an evaluation process in which an action related to the task of the subject is evaluated on the basis of the information related to a behavior of the subject acquired by the acquisition device, a selection process in which an expression of the face image is selected with reference to the correspondence information on the basis of the feeling of the subject specified by the specification process and an evaluation result of the evaluation process, and an output process in which the face image of the expression selected by the selection process is output by the output device.

According to a representative embodiment of the invention, it is possible to effectively motivate the subject. Objects, configurations, and effects besides the above description will be apparent through the explanation on the following embodiments.

### BRIEF DESCRIPTION OF THE DRAWINGS

FIG. 1 is an exterior view of an action support device;

FIG. 2 is a block diagram illustrating an exemplary hardware configuration of the action support device;

FIG. 3 is a diagram for describing an example of a conversion table;

FIG. 4 is a diagram for describing an example of the correspondence information according to a first embodiment;

FIG. 5 is a diagram for describing an example of an agent expression;

FIG. 6 is a block diagram illustrating an exemplary functional configuration of the action support device according to the first embodiment;

FIG. 7 is a diagram for describing an evaluation processing content of the evaluation unit;

FIG. 8 is a flowchart illustrating an exemplary action support processing procedure of the action support device according to the first embodiment;

FIG. 9 is a flowchart illustrating a detailed exemplary action support processing procedure relating to a first task of the action support device according to the first embodiment;

FIG. 10 is a flowchart illustrating a detailed exemplary action support processing procedure relating to a second task of the action support device according to the first embodiment;

FIG. 11 is a flowchart illustrating a detailed exemplary action support processing procedure relating to a third task of the action support device according to the first embodiment;

FIG. 12 is a flowchart illustrating a detailed exemplary action support processing procedure relating to a fourth task of the action support device according to the first embodiment;

FIG. 13 is a diagram for describing an example of the correspondence information according to a second embodiment;

FIG. 14 is a diagram for describing an example of the correspondence information according to a third embodiment;

FIG. 15 is a diagram for describing an example of the correspondence information according to a fourth embodiment;

FIG. 16 is a block diagram illustrating an exemplary functional configuration of the action support device according to the fourth embodiment; and

FIG. 17 is a flowchart illustrating an exemplary action support processing procedure of the action support device according to the fourth embodiment.

### DESCRIPTION OF THE PREFERRED EMBODIMENTS

### First Embodiment

An action support device is a computer which supports the action of a subject of an action support, and displays an expression appropriate for each of the segmentalized tasks while changing the expression to realize a conversation with the subject. In a first embodiment, the description will be given about a case where the subject is a patient, and the action support device is a medication device which urges the patient to take a medicine.

For example, in a case where the action support device is a medication device, the action support device executes a first task TK1 to urge the subject to approach the action support device, a second task TK2 to urge the subject to pull out a pill case from the action support device, a third task TK3 to urge the subject who has pulled out the pill case to pick out the medicine from the pill case, and a fourth task TK4 to urge the subject who picks out the medicine to take the medicine. The first task TK1 to the fourth task TK4 are a series of segmentalized tasks set in order.

### Appearance of Action Support Device

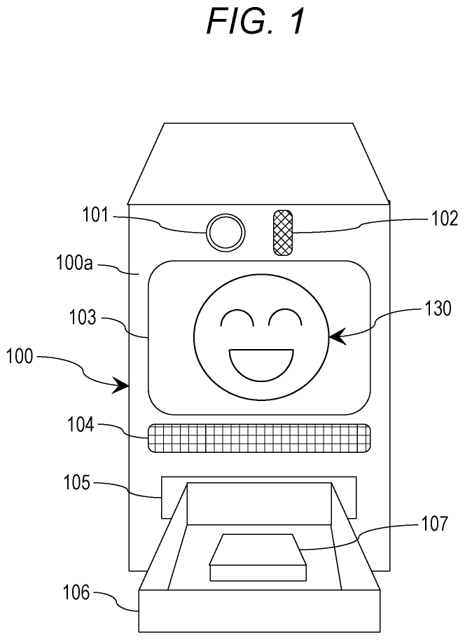

FIG. 1 is an exterior view of the action support device. An action support device 100 includes a camera 101, a microphone 102, a display device 103, a speaker 104, a tray insert hole 105, and a tray 106 in a front surface 100a. The camera 101 captures images of the appearance from the front surface 100a of the action support device 100 and the subject who reaches the front surface 100a. The microphone 102 inputs a voice in the front surface 100a of the action support device 100.

The display device 103 displays an agent 130 which is a personified conversation partner of the subject. The speaker 104 outputs a voice spoken by the agent and other sounds. The tray insert hole 105 is a space to insert the tray 106. The tray 106 moves back and forth in a direction perpendicular to the front surface 100a. A pill case 107 with medicines is placed in the tray 106.

### Exemplary Hardware Configuration of Action Support Device 100

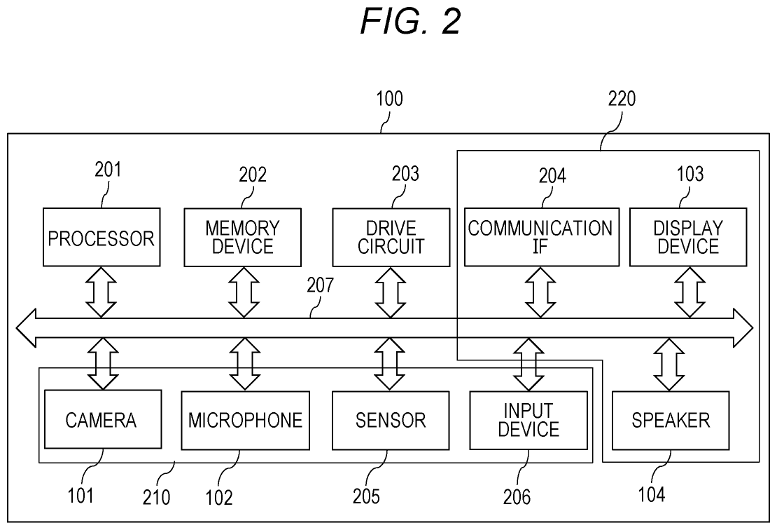

FIG. 2 is a block diagram illustrating an exemplary hardware configuration of the action support device 100. The action support device 100 includes a processor 201, a memory device 202, a drive circuit 203, a communication interface (the communication IF) 204, the display device 103, the camera 101, the microphone 102, a sensor 205, an input device 206, and the speaker 104 which are connected through a bus 207.

The processor 201 controls the action support device 100. The memory device 202 is a work area of the processor 201. In addition, the memory device 202 is a temporal or non-temporal recording medium to store various programs and data (including the face image of the subject). Examples of the memory device 202 include a Read Only Memory (ROM), a Random Access Memory (RAM), a Hard Disk Drive (HDD), and a flash memory.

The drive circuit 203 controls the driving of a drive mechanism of the action support device 100 by a command from the processor 201 to move the tray 106 back and forth. The communication IF 204 is connected to a network, and transfers data. The sensor 205 detects a physical phenomenon and a physical state of the target. The sensor 205 includes, for example, a distance measuring sensor to measure a distance to the subject, an infrared sensor to detect whether the pill case 107 is pulled out of the tray 106, and a metering sensor to measure the pill case 107 placed on the tray 106.

The input device 206 is a button or a touch panel to input data by the subject's touch. The camera 101, the microphone 102, the sensor 205, and the input device 206 are collectively called “acquisition device 210” to acquire information related to the subject. In addition, the communication IF 204, the display device 103, and the speaker 104 are collectively called “output device 220” to output information to the subject.

### Conversion Table

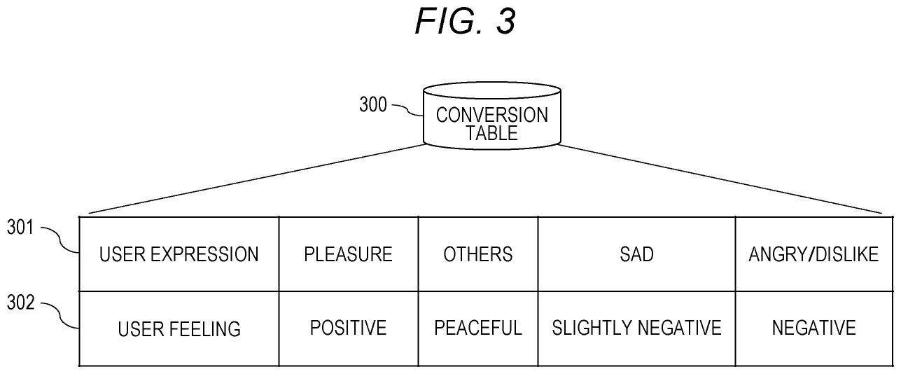

FIG. 3 is a diagram for describing an example of a conversion table. A conversion table 300 is a table to convert the expression of the subject (hereinafter, a user expression) 301 acquired by the acquisition device 210 of the action support device 100 into a subject' feeling (hereinafter, a user feeling) 302. The conversion table 300 is stored in the memory device 202. With this configuration, the action support device 100 can specify a feeling of the subject from the expression of the subject.

### Correspondence Information

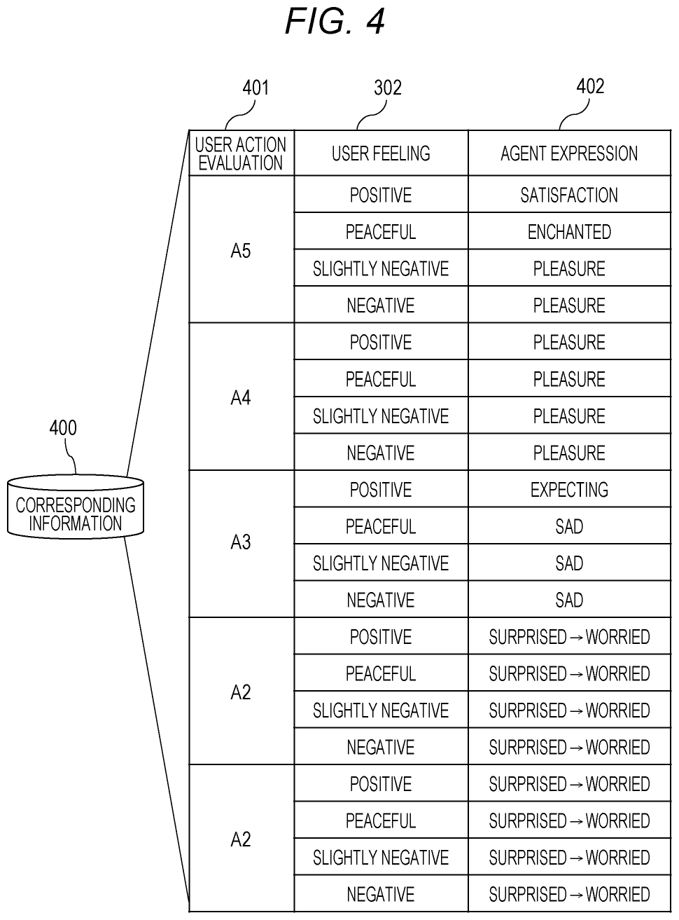

FIG. 4 is a diagram for describing an example of the correspondence information according to the first embodiment. The correspondence information 400 is a table in which an evaluation result of the subject's action (hereinafter, a user action evaluation) 401, the user feeling 302, and the expression of the agent 130 (hereinafter, an agent expression) 402 are associated. The correspondence information 400 is stored in the memory device 202.

The correspondence information 400 is a table to select the agent expression 402 by a combination of the user action evaluation 401 and the user feeling 302. With this configuration, the action support device 100 can guide the subject's action in a direction desired to be induced by the action support device 100 according to the expression of the agent toward the subject. Further, in FIG. 4, while the task is not specified, the entry value may differ for each task even though the correspondence information 400 is common to all the tasks.

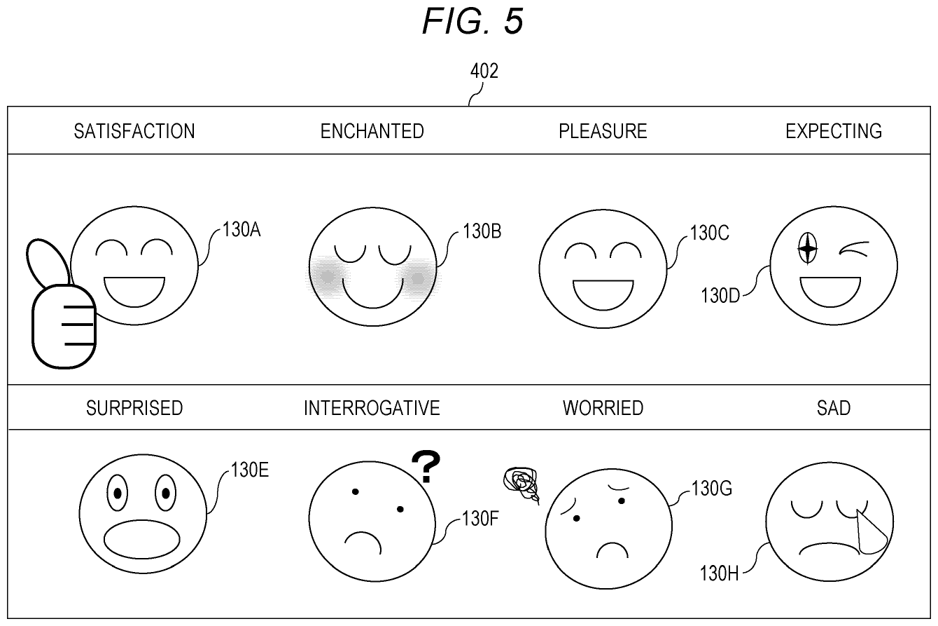

FIG. 5 is a diagram for describing an example of an agent expression 402. The agent expression 402 includes, for example, face images 130A to 130H of the agent 130 indicating the expressions of “satisfaction”, “enchanted”, “pleasure”, “expecting”, “surprised”, “interrogative”, “worried”, and “sad”. These face images 130A to 130H are output from the output device 220. Further, if not otherwise specified in the agent expression 402, it will be simply denoted as the agent 130. Further, the agent expression 402 illustrated in FIG. 5 is a mere example, and other agent expression 402 may be employed.

### Exemplary Functional Configuration of Action Support Device 100

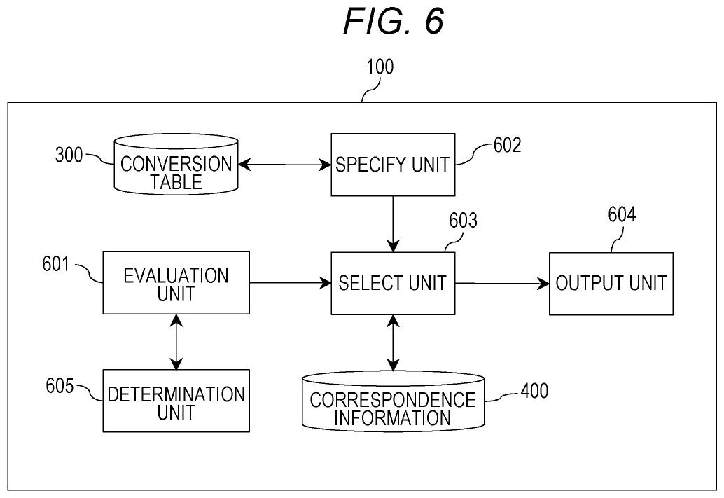

FIG. 6 is a block diagram illustrating an exemplary functional configuration of the action support device 100 according to the first embodiment. The action support device 100 includes an evaluation unit 601, a specify unit 602, a select unit 603, an output unit 604, a determination unit 605, the conversion table 300, and the correspondence information 400. For example, the evaluation unit 601 to the determination unit 605 are specifically realized by causing the processor 201 to perform a program stored in the memory device 202 illustrated in FIG. 2, for example.

The evaluation unit 601 evaluates an action related to the task of the subject on the basis of information related to a behavior of the subject acquired by the acquisition device 210. The behavior of the subject is a motion when the subject acts in the task, and includes, for example, a motion of approaching up to the action support device 100 in the case of the first task TK1, a motion of drawing out the tray 106 of the pill case 107 in the case of the second task TK2, a motion of picking up a medicine from the pill case 107 in the case of the third task TK3, and a motion of taking a medicine in the case of the fourth task TK4.

The information related to the behavior indicating these motions includes, for example, a size of the face image of the subject captured by the camera 101 and a distance up to the subject acquired by a distance measuring sensor in the case of the first task TK1, a difference between metering values before and after the pill case 107 is pulled out in the metering sensor installed in the tray 106 and a presence/absence of the pill case 107 captured by an infrared sensor or an internal camera installed in the tray 106 in the case of the second task TK2, a different between metering values before and after the pill case 107 is returned in the metering sensor installed in the tray 106 in the case of the third task TK3, and a response voice of the subject from the microphone 102 to a voice of the agent 130 to confirm whether a medicine is take and an input from the input device 206 indicating that the medicine is taken in the case of the fourth task TK4.

The evaluation unit 601 evaluates the action related to the task of the subject on the basis of the information related to the behavior of the subject. The action related to the task of the subject is a user action specified by an action parameter (described below) which is defined for each task. In this example, the evaluation unit 601 evaluates the user action in five steps (A5 to A1).

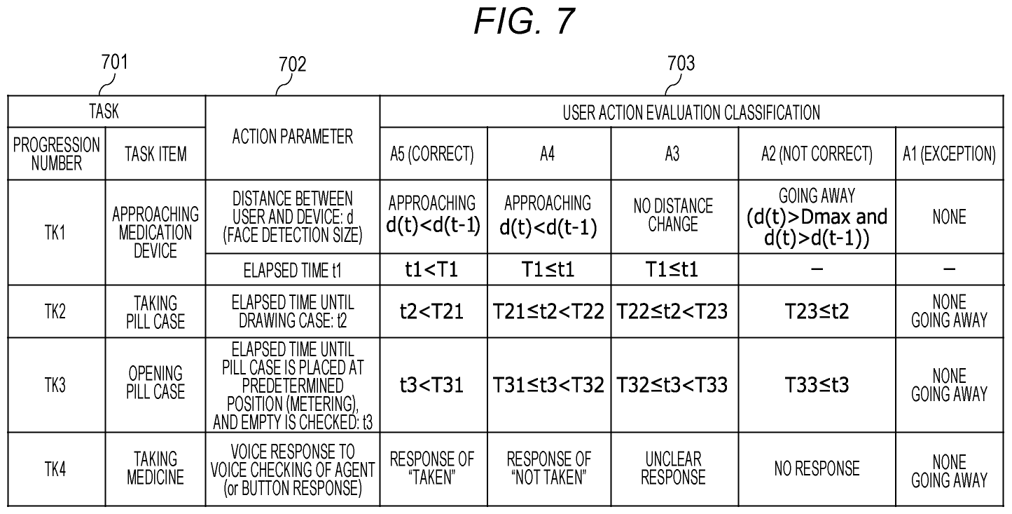

FIG. 7 is a diagram for describing an evaluation processing content of the evaluation unit 601. In the evaluation process, the user action is evaluated by a task 701, an action parameter 702, and a user action evaluation classification 703. The task 701 defines the first task TK1 to the fourth task TK4. The action parameter is a parameter to define the user action, and is set for each task.

The user action evaluation 401 evaluates a user's correct action in the five steps (A5 to A1). The evaluation Ai (i is an integer of 1 to 5) indicates a high evaluation as i increases. A5 indicates the highest evaluation, A2 indicates the lowest evaluation, and A1 indicates an exception. Hereinbelow, the description will be given in detail about the relation between the task 701, the action parameter 702, and the user action evaluation classification 703.

The task 701 is specified by a combination of proceeding numbers TK1 to TK4 and a task item. For example, the task item “to approach the medication device” of the proceeding number TK1 becomes the first task TK1. The proceeding numbers TK2 to TK4 are also similarly specified.

The action parameter 702 differs at each task. For example, in the case of the first task TK1, the action parameter 702 is a distance d between the subject and the action support device 100 and an elapsed time t1. The distance d is specified by a size of the face image of the subject captured by the camera 101. In other words, the distance d becomes short as the face image is increased in size. A counting time point of the elapsed time t1 is a time point when the face of the subject starts to be detected. The user action evaluation classification 703 becomes high as the distance d and the elapsed time t1 become short.

For example, in a case where a current detection distance d(t) is shorter than a previous detection distance d(t−1) and the elapsed time t1 is shorter than a threshold T1, it shows that the subject quickly approaches the action support device 100. Therefore, the evaluation unit 601 sets the user action evaluation 401 to “A5”. Further, a detection interval of the face image is assumed to be set in advance.

In addition, in a case where the current detection distance d(t) is shorter than the previous detection distance d(t−1) but the elapsed time t1 is equal to or more than the threshold T1, it shows that the subject approaches the action support device 100. Therefore, the evaluation unit 601 sets the user action evaluation 401 to “A4”.

In addition, in a case where the current detection distance d(t) and the previous detection distance d(t−1) are equal and the elapsed time tl is equal to or more than the threshold T1, it shows that there is no change in the distance d between the subject and the action support device 100. Therefore, the evaluation unit 601 sets the user action evaluation 401 to “A3”.

In addition, in a case where the current detection distance d(t) is longer than a maximum distance Dmax and the current detection distance d(t) is longer than the previous detection distance d(t−1), it shows that the subject goes away from the action support device 100. Therefore, the evaluation unit 601 sets the user action evaluation 401 to “A2”.

In addition, in a case where the distance d is not detected, that is, in a case where the camera 101 is not able to capture the face image of the subject, it shows that the subject is not in front of the action support device 100. Therefore, the evaluation unit 601 sets the user action evaluation 401 to “A1” indicating an exception.

In the case of the second task TK2, the action parameter 702 is an elapsed time t2 taken until the pill case 107 is pulled out of the tray 106 after the tray 106 is drawn out of the tray insert hole 105. The counting time point of the elapsed time t2 is a time point when the tray 106 is drawn out of the tray insert hole 105. The end time point of the elapsed time t2 is a time point when the metering value of the pill case 107 is not detected by the metering sensor, or a time point when the pill case 107 is not detected by an infrared sensor or the internal camera. The user action evaluation 401 becomes high as the elapsed time t2 becomes short.

For example, in a case where the elapsed time t2 is shorter than a threshold T21, it shows that the subject pulls out the pill case 107 immediately. Therefore, the evaluation unit 601 sets the user action evaluation 401 to “A5”.

In addition, in a case where the elapsed time t2 is equal to or more than the threshold T21 and less than a threshold T22 (T21<T22), it shows that the subject pulls out the pill case 107. Therefore, the evaluation unit 601 sets the user action evaluation 401 to “A4”.

In addition, in a case where the elapsed time t2 is equal to or more than the threshold T22 and less than a threshold T23 (T22 <T23), it shows that the subject pulls out the pill case 107 after long time. Therefore, the evaluation unit 601 sets the user action evaluation 401 to “A3”.

In addition, in a case where the elapsed time t2 is equal to or more than the threshold T23, it shows that the subject finally pulls out the pill case 107. Therefore, the evaluation unit 601 sets the user action evaluation 401 to “A2”.

In addition, in a case where the camera 101 is not able to capture the face image of the subject, it shows that the subject is not in front of the action support device 100. Therefore, the evaluation unit 601 sets the user action evaluation 401 to “A1” indicating an exception.

In the case of the third task TK3, the action parameter 702 is an elapsed time t3 taken until it is confirmed that a medicine is picked out of the pill case 107. The counting time point of the elapsed time t3 is an end time point of the elapsed time t2. The end time point of the elapsed time t3 is a time point when the pill case 107 is placed in the tray 106 and the metering value of the medicine is not detected by the metering sensor.

For example, in a case where the elapsed time t3 is shorter than a threshold T31, it shows that the subject picks out a medicine from the pill case 107 immediately. Therefore, the evaluation unit 601 sets the user action evaluation 401 to “A5”.

In addition, in a case where the elapsed time t3 is equal to or more than the threshold T31 and less than a threshold T32 (T31<T32), it shows that the subject picks out a medicine from the pill case 107. Therefore, the evaluation unit 601 sets the user action evaluation 401 to “A4”.

In addition, in a case where the elapsed time t3 is equal to or more than the threshold T32 and less than a threshold T33 (T32<T33), it shows that the subject picks out a medicine from the pill case 107 after long time. Therefore, the evaluation unit 601 sets the user action evaluation 401 to “A3”.

In addition, in a case where the elapsed time t3 is equal to or more than the threshold T33, it shows that the subject finally picks out a medicine from the pill case 107. Therefore, the evaluation unit 601 sets the user action evaluation 401 to “A2”.

In addition, in a case where the camera 101 is not able to capture the face image of the subject, it shows that the subject is not in front of the action support device 100. Therefore, the evaluation unit 601 sets the user action evaluation 401 to “A1” indicating an exception.

In the case of the fourth task TK4, the action parameter 702 is a response voice of the subject from the microphone 102 to a voice of the agent 130 to confirm whether a medicine is taken and an analysis result of an input from the input device 206 indicating that a medicine is taken.

For example, in a case where the analysis result is “taken”, the evaluation unit 601 sets the user action evaluation 401 to “A5”. In addition, in a case where the analysis result is “not taken” or “not yet”, the evaluation unit 601 sets the user action evaluation 401 to “A4”. In addition, in a case where the analysis result cannot be analyzed, the evaluation unit 601 sets the user action evaluation 401 to “A3”.

In addition, in a case where the analysis result is no response, the evaluation unit 601 sets the user action evaluation 401 to “A2”. In addition, in a case where the camera 101 is not able to capture the face image of the subject, it shows that the subject is not in front of the action support device 100. Therefore, the evaluation unit 601 sets the user action evaluation 401 to “A1” indicating an exception. In this way, the evaluation unit 601 evaluates the user action for each task, and outputs any one of A5 to A1 as the evaluation result for each task.

The specify unit 602 specifies a feeling of the subject on the basis of the information related to the expression of the subject acquired by the acquisition device 210. Specifically, for example, the specify unit 602 analyzes the face image of the subject captured by the camera 101 to specify the feeling of the subject.

Specifically, for example, the specify unit 602 recognizes the expression of the subject's face according to a difference from an expressionless face and a change in portions of the face, such as eyes, mouth (including an exposure of teeth), nose, and eyebrow using the face image of the subject captured by the camera 101. Further, in recognizing the face expression, a rule base, that is, a template image indicating each expression is registered.

The specify unit 602 retrieves features of the portions of the face in each expression in the template image to recognize the expression of the face image from the camera 101. In addition, a learning model is generated by inputting a training image having a correct level of each expression through learning with a model. The specify unit 602 assigns the face image from the camera 101 to the learning model to recognize the expression of the face image.

The specify unit 602 specifies the user feeling 302 corresponding to the user expression 301 which is the subject's expression thus recognized using the conversion table 300. With this configuration, the user feeling 302 is specified to any one of “positive”, “peaceful”, “slightly negative”, and “negative”.

The select unit 603 selects an expression of the face image output from the output device 220 with reference to the correspondence information 400 on the basis of the evaluation result of the evaluation unit 601 and the user feeling 302 specified by the specify unit 602. The face image output from the output device 220 is a face image of the agent 130. Specifically, for example, the select unit 603 selects the agent expression 402 corresponding to the user action and the user feeling 302. For example, if the user action is “A5” and the user feeling 302 is “positive”, “satisfaction” is selected as the agent expression 402.

The output unit 604 outputs the agent expression 402 selected by the select unit 603 from the output device 220. The output unit 604 may output the agent expression 402 as the face image of the agent 130, or may output a character string indicating the agent expression 402 or a spoken voice of the character string.

In addition, in a case where the output device 220 is the display device 103, the output unit 604 displays the face image of the agent 130 in the display device 103. For example, in a case where “satisfaction” is selected as the agent expression 402 by the select unit 603, the output unit 604 displays the face image 130A of the agent 130 of which the agent expression 402 illustrated in FIG. 5 is “satisfaction” in the display device 103. Further, the character string indicating the agent expression 402 may be displayed in the display device 103 instead of the face image or in addition to the agent 130.

In addition, in a case where the output device 220 is the speaker 104, a voice is output from the speaker 104 to speak the character string indicating the selected agent expression 402. In addition, in a case where the output device 220 is the communication IF 204, the output unit 604 transmits the face image, the character string, and the spoken voice indicating the agent expression 402 to the other computer connected in a communicable manner through the communication IF 204. With this configuration, the agent expression 402 can be output by the other computer.

In a case where the agent expression 402 is output by the output unit 604, the determination unit 605 determines whether the task is successively executed on the basis of the evaluation result of the action related to the task by the evaluation unit 601. In a case where the task is successively executed, the process moves to the next task. Then, the evaluation unit 601 evaluates the user action in the next task.

For example, in the case of the first task TK1, the determination unit 605 determines whether the subject exists within a distance Dmin (<Dmax) to the action support device 100. In a case where the subject exists within the distance Dmin, the determination unit 605 determines that the subject succeeds in the execution of the first task TK1. In a case where the execution of the first task TK1 is successful, the action support device 100 controls the drive circuit 203 to draw out the tray 106 from the tray insert hole 105. On the other hand, in a case where the evaluation result becomes A1, the determination unit 605 determines that the subject fails in the execution of the first task TK1.

In addition, in the case of the second task TK2, in a case where the pill case 107 is detected to be pulled out of the tray 106 by a difference of the metering value of the metering sensor before and after the pill case 107 is pulled out, the determination unit 605 determines that the execution of the second task TK2 is successful. Until the pill case 107 is detected to be pulled out of the tray 106, the determination unit 605 suspends the determination on whether the execution of the second task TK2 is successful. In addition, in a case where the evaluation result becomes A1, the determination unit 605 determines that the subject fails in the execution of the second task TK2.

In addition, in the case of the third task TK3, in a case where a medicine is detected to be picked out of the pill case 107 by a difference of the metering value of the metering sensor before and after the pill case 107 is placed, the determination unit 605 determines that the execution of the third task TK3 is successful. Until a medicine is detected to be picked out of the pill case 107, the determination unit 605 suspends the determination on whether the execution of the third task TK3 is successful. In addition, in a case where the evaluation result becomes A1, the determination unit 605 determines that the subject fails in the execution of the third task TK3.

In addition, in the case of the fourth task TK4, if the evaluation result is A5, the determination unit 605 determines that the execution of the fourth task TK4 is successful. If the evaluation result is A4 to A2, the determination unit 605 suspends the determination on whether the execution of the fourth task TK4 is successful. If the evaluation result is A1, the determination unit 605 determines that the subject fails in the execution of the fourth task TK4. In addition, if the evaluation result is A4 to A2, the determination unit 605 may determine that the subject fails in the execution of the fourth task TK4.

### Exemplary Action Support Processing Procedure

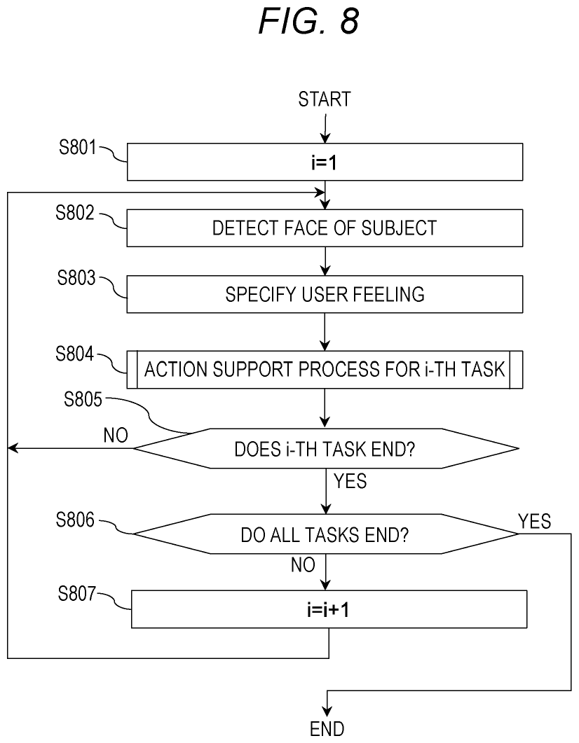

FIG. 8 is a flowchart illustrating an exemplary action support processing procedure of the action support device 100 according to the first embodiment. The action support device 100 sets an iteration i of the proceeding number TKi to be i=1 (Step S801), and detects the face of the subject by the camera 101 (Step S802). Next, the action support device 100 specifies the user feeling 302 from the expression of the detected face image of the subject by the specify unit 602 (Step S803).

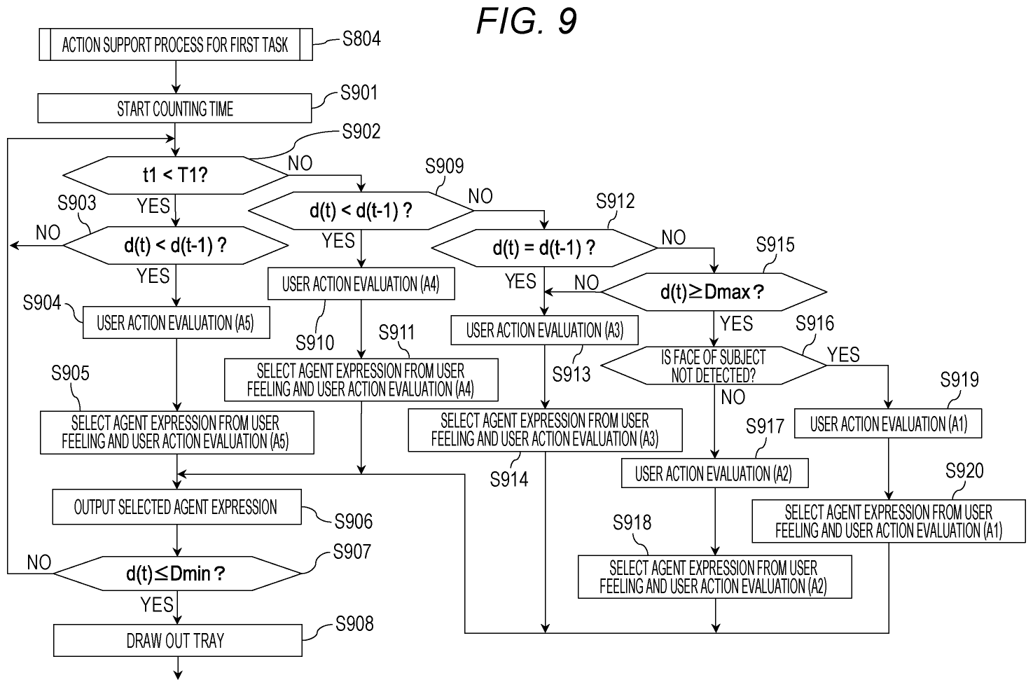

Then, the action support device 100 performs the action support process related to an i-th task TKi (Step S804). While the action support process related to the i-th task TKi (Step 5804) will be described below using FIGS. 9 to 12, the process can support the subject to execute the task for each task. Then, the action support device 100 determines whether the i-th task TKi is ended (Step S805). In a case where the i-th task TKi is not ended (Step S805: No), the process returns to Step S802.

On the other hand, in a case where the i-th task TKi is ended (Step S805: Yes), the action support device 100 determines whether all the tasks are ended (Step S806). In a case where all the tasks are not ended (Step S806: No), the action support device 100 increases the iteration i (Step S807), and the process returns to Step S802 to move to the next task. On the other hand, in a case where all the tasks are ended (Step S806: Yes), the action support device 100 ends a series of processes.

### Procedure Example of Action Support Process related to i-th Task TKi (Step S804)

FIG. 9 is a flowchart illustrating a detailed exemplary action support processing procedure relating to the first task TK1 of the action support device 100 according to the first embodiment. The action support device 100 first starts counting time for the first task TK1 (Step S901), and determines whether the elapsed time t1 after the counting start (Step S901) is less than the threshold T1 (Step S902).

In a case where the elapsed time t1 is equal to or more than the threshold T1 (Step S902: No), the process moves to Step S909. On the other hand, in a case where the elapsed time t1 is less than the threshold T1 (Step S902: Yes), the action support device 100 determines whether the current detection distance d(t) up to the action support device 100 from the subject is less than the previous detection distance d(t−1), that is, whether the subject approaches the action support device 100 compared to the previous time (Step S903).

In a case where the current detection distance d(t) is equal to or more than the previous detection distance d(t−1) (Step S903: No), the process returns to Step S902. On the other hand, in a case where the current detection distance d(t) is less than the previous detection distance d(t−1) (Step S903: Yes), the action support device 100 sets the user action evaluation 401 to “A5” as illustrated in FIG. 7 by the evaluation unit 601 (Step S904).

Then, the action support device 100 selects the agent expression 402 corresponding to a combination of the user feeling 302 specified in Step S803 of FIG. 8 and the user action evaluation 401 set in Step S904 with reference to the correspondence information 400 illustrated in FIG. 4 (Step S905). Then, the action support device 100 outputs the selected agent expression 402 by the output unit 604 (Step S906).

Then, the action support device 100 determines whether the current detection distance d(t) is equal to or less than the distance Dmin (Step S907). In a case where the current detection distance d(t) is not equal to or less than the distance Dmin (Step S907: No), the subject does not sufficiently approach to the action support device 100. Therefore, the process returns to Step S902. On the other hand, in a case where the current detection distance d(t) is equal to or less than the distance Dmin (Step S907: Yes), the action support device 100 controls the drive circuit 203 to draw out the tray 106 from the tray insert hole 105 (Step S908). With this configuration, the first task TK1 ends.

In addition, in Step S909, similarly to Step S903, the action support device 100 determines whether the current detection distance d(t) up to the action support device 100 from the subject is less than the previous detection distance d(t−1), that is, whether the subject approaches to the action support device 100 compared to the previous time (Step S909).

In a case where the current detection distance d(t) is equal to or more than the previous detection distance d(t−1) (Step S909: No), the process proceeds to Step S912. On the other hand, in a case where the current detection distance d(t) is less than the previous detection distance d(t−1) (Step 5909: Yes), the action support device 100 sets the user action evaluation 401 to “A4” as illustrated in FIG. 7 by the evaluation unit 601 (Step S910).

Then, the action support device 100 selects the agent expression 402 corresponding to a combination of the user feeling 302 specified in Step S803 of FIG. 8 and the user action evaluation 401 set in Step S910 with reference to the correspondence information 400 illustrated in FIG. 4 (Step S911). Then, the process moves to Step S906.

In addition, in Step S912, the action support device 100 determines whether the current detection distance d(t) up to the action support device 100 from the subject is equal to the previous detection distance d(t−1) (Step S912).

In a case where the current detection distance d(t) is not equal to the previous detection distance d(t−1) (Step S912: No), the process moves to Step S915. On the other hand, in a case where the current detection distance d(t) is equal to the previous detection distance d(t−1) (Step S912: Yes), the action support device 100 sets the user action evaluation 401 to “A3” as illustrated in FIG. 7 by the evaluation unit 601 (Step S913).

Then, the action support device 100 selects the agent expression 402 corresponding to a combination of the user feeling 302 specified in Step S803 of FIG. 8 and the user action evaluation 401 set in Step S913 with reference to the correspondence information 400 illustrated in FIG. 4 (Step S914). Then, the process moves to Step S906.

In addition, in Step S915, the action support device 100 determines whether the current detection distance d(t) up to the action support device 100 from the subject is equal to or more than the maximum distance Dmax (Step S915).

In a case where the current detection distance d(t) is not equal to or more than the maximum distance Dmax (Step S915: No), the process moves to Step S913. The action support device 100 sets the user action evaluation 401 to “A3” as illustrated in FIG. 7 by the evaluation unit 601. On the other hand, in a case where the current detection distance d(t) is equal to or more that the maximum distance Dmax (Step S915: Yes), the action support device 100 determines whether the face of the subject is not detected (Step S916). In a case where the face of the subject is detected (Step S916: No), the action support device 100 sets the user action evaluation 401 to “A2” as illustrated in FIG. 7 by the evaluation unit 601 (Step S917).

Then, the action support device 100 selects the agent expression 402 corresponding to a combination of the user feeling 302 specified in Step S803 of FIG. 8 and the user action evaluation 401 set in Step S917 with reference to the correspondence information 400 illustrated in FIG. 4 (Step S918). Then, the process moves to Step S906.

On the other hand, in a case where the face of the subject is not detected (Step S916: Yes), the action support device 100 sets the user action evaluation 401 to “A1” as illustrated in FIG. 7 by the evaluation unit 601 (Step S919).

Then, the action support device 100 selects the agent expression 402 corresponding to a combination of the user feeling 302 specified in Step S803 of FIG. 8 and the user action evaluation 401 set in Step S917 with reference to the correspondence information 400 illustrated in FIG. 4 (Step S920). Then, the process moves to Step S906. In this way, when Step S908 is executed, the subject comes to execute the first task TK1.

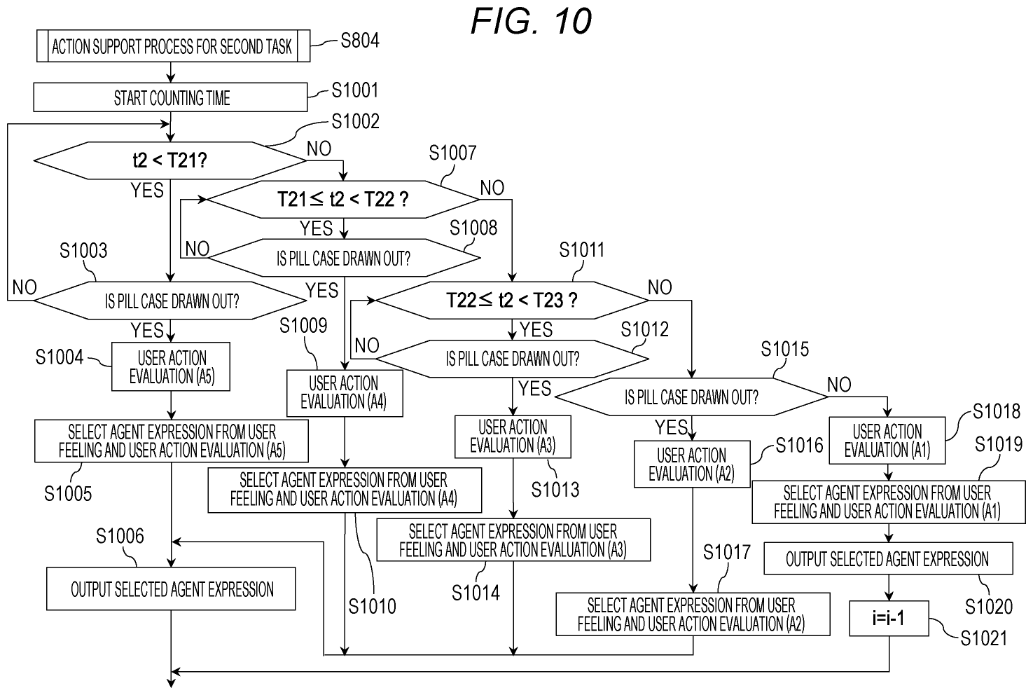

FIG. 10 is a flowchart illustrating a detailed exemplary action support processing procedure relating to the second task TK2 of the action support device 100 according to the first embodiment. The action support device 100 first starts counting time for the second task TK2 (Step S1001), and determines whether the elapsed time t2 after the counting start (Step S1001) is less than the threshold T21 (Step S1002).

In a case where the elapsed time t2 is equal to or more than the threshold T21 (Step S1002: No), the process moves to Step S1007. On the other hand, in a case where the elapsed time t2 is less than the threshold T21 (Step S1002: Yes), the action support device 100 determines whether the pill case 107 is pulled out of the tray 106 by the subject (Step S1003).

In a case where the pill case 107 is not pulled out of the tray 106 by the subject (Step S1003: No), the process returns to Step S1002. On the other hand, in a case where the pill case 107 is pulled out of the tray 106 by the subject (Step S1003: Yes), the action support device 100 sets the user action evaluation 401 to “A5” as illustrated in FIG. 7 by the evaluation unit 601 (Step S1004).

Then, the action support device 100 selects the agent expression 402 corresponding to a combination of the user feeling 302 specified in Step S803 of FIG. 8 and the user action evaluation 401 set in Step S1004 with reference to the correspondence information 400 illustrated in FIG. 4 (Step S1005). Then, the action support device 100 outputs the selected agent expression 402 by the output unit 604 (Step S1006). With this configuration, the subject comes to execute the second task TK2.

In addition, in Step S1007, the action support device 100 determines whether the elapsed time t2 is equal to or more than the threshold T21 and less than the threshold T22 (Step S1007). In a case where the elapsed time t2 is equal to or more than the threshold T21 and not less than the threshold T22 (Step S1007: No), the process moves to Step S1011. On the other hand, in a case where the elapsed time t2 is equal to or more than the threshold T21 and less than the threshold T22 (Step S1007: Yes), the action support device 100 determines whether the pill case 107 is pulled out of the tray 106 by the subject (Step S1008).

In a case where the pill case 107 is not pulled out of the tray 106 by the subject (Step S1008: No), the process returns to Step S1007. On the other hand, in a case where the pill case 107 is pulled out of the tray 106 by the subject (Step S1008: Yes), the action support device 100 sets the user action evaluation 401 to “A4” as illustrated in FIG. 7 by the evaluation unit 601 (Step S1009).

Then, the action support device 100 selects the agent expression 402 corresponding to a combination of the user feeling 302 specified in Step S803 of FIG. 8 and the user action evaluation 401 set in Step S1009 with reference to the correspondence information 400 illustrated in FIG. 4 (Step S1010). Then, the process moves to Step S1006. With this configuration, the subject comes to execute the second task TK2.

In addition, in Step S1011, the action support device 100 determines whether the elapsed time t2 is equal to or more than the threshold T22 and less than the threshold T23 (Step S1011). In a case where the elapsed time t2 is equal to or more than the threshold T22 and not less than the threshold T23 (Step S1011: No), the process moves to Step S1015. On the other hand, in a case where the elapsed time t2 is equal to or more than the threshold T22 and less than the threshold T23 (Step S1011: Yes), the action support device 100 determines whether the pill case 107 is pulled out of the tray 106 by the subject (Step S1012).

In a case where the pill case 107 is not pulled out of the tray 106 by the subject (Step S1012: No), the process returns to Step S1011. On the other hand, in a case where the pill case 107 is pulled out of the tray 106 by the subject (Step S1012: Yes), the action support device 100 sets the user action evaluation 401 to “A3” as illustrated in FIG. 7 by the evaluation unit 601 (Step S1009).

Then, the action support device 100 selects the agent expression 402 corresponding to a combination of the user feeling 302 specified in Step S803 of FIG. 8 and the user action evaluation 401 set in Step S1013 with reference to the correspondence information 400 illustrated in FIG. 4 (Step S1014). Then, the process moves to Step S1006. With this configuration, the subject comes to execute the second task TK2.

In addition, in Step S1015, the action support device 100 determines whether the pill case 107 is pulled out of the tray 106 by the subject (Step S1015). In a case where the pill case 107 is pulled out of the tray 106 by the subject (Step S1015: Yes), the action support device 100 sets the user action evaluation 401 to “A2” as illustrated in FIG. 7 by the evaluation unit 601 (Step S1016).

Then, the action support device 100 selects the agent expression 402 corresponding to a combination of the user feeling 302 specified in Step S803 of FIG. 8 and the user action evaluation 401 set in Step S1016 with reference to the correspondence information 400 illustrated in FIG. 4 (Step S1017). Then, the process moves to Step S1006. With this configuration, the subject comes to execute the second task TK2.

On the other hand, in a case where the pill case 107 is not pulled out of the tray 106 by the subject (Step S1015: No), the action support device 100 sets the user action evaluation 401 to “A1” as illustrated in FIG. 7 by the evaluation unit 601 (Step S1018). Then, the action support device 100 selects the agent expression 402 corresponding to a combination of the user feeling 302 specified in Step S803 of FIG. 8 and the user action evaluation 401 set in Step S1018 with reference to the correspondence information 400 illustrated in FIG. 4 (Step S1019).

Then, the action support device 100 outputs the selected agent expression 402 by the output unit 604 (Step S1020), and decreases the iteration i to return from the second task TK2 to the first task TK1 (Step S1021). In this case, the subject comes not to execute the second task TK2.

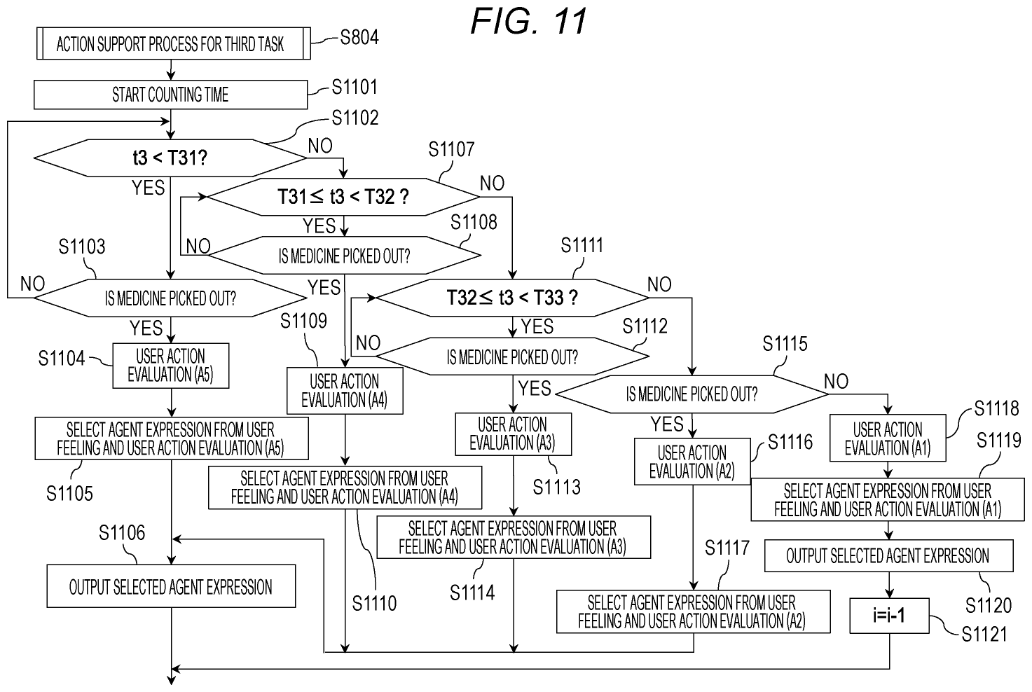

FIG. 11 is a flowchart illustrating a detailed exemplary action support processing procedure relating to the third task TK3 of the action support device 100 according to the first embodiment. The action support device 100 first starts counting time for the third task TK3 (Step S1101), and determines whether the elapsed time t3 after the counting start (Step S1101) is less than the threshold T31 (Step S1102).

In a case where the elapsed time t3 is equal to or more than the threshold T31 (Step S1102: No), the process moves to Step S1107. On the other hand, in a case where the elapsed time t3 is less than the threshold T31 (Step S1102: Yes), the action support device 100 determines whether a medicine is picked out of the pill case 107 by the subject (Step S1103).

In a case where a medicine is not picked out of the pill case 107 by the subject (Step S1103: No), the process returns to Step S1102. On the other hand, in a case where a medicine is picked out of the pill case 107 by the subject (Step S1103: Yes), the action support device 100 sets the user action evaluation 401 to “A5” as illustrated in FIG. 7 by the evaluation unit 601 (Step S1104).

Then, the action support device 100 selects the agent expression 402 corresponding to a combination of the user feeling 302 specified in Step S803 of FIG. 8 and the user action evaluation 401 set in Step S1104 with reference to the correspondence information 400 illustrated in FIG. 4 (Step S1105). Then, the action support device 100 outputs the selected agent expression 402 by the output unit 604 (Step S1106). With this configuration, the subject comes to execute the third task TK3.

In addition, in Step S1107, the action support device 100 determines whether the elapsed time t3 is equal to or more than the threshold T31 and less than the threshold T32 (Step S1107). In a case where the elapsed time t3 is equal to or more than the threshold T31 and not less than the threshold T32 (Step S1107: No), the process moves to Step S1111. On the other hand, in a case where the elapsed time t3 is equal to or more than the threshold T31 and less than the threshold T32 (Step S1107: Yes), the action support device 100 determines whether a medicine is picked out of the pill case 107 by the subject (Step S1108).

In a case where a medicine is not picked out of the pill case 107 by the subject (Step S1108: No), the process returns to Step S1107. On the other hand, in a case where a medicine is picked out of the pill case 107 by the subject (Step S1108: Yes), the action support device 100 sets the user action evaluation 401 to “A4” as illustrated in FIG. 7 by the evaluation unit 601 (Step S1109).

Then, the action support device 100 selects the agent expression 402 corresponding to a combination of the user feeling 302 specified in Step S803 of FIG. 8 and the user action evaluation 401 set in Step S1109 with reference to the correspondence information 400 illustrated in FIG. 4 (Step S1110). Then, the process moves to Step S1106. With this configuration, the subject comes to execute the third task TK3.

In addition, in Step S1111, the action support device 100 determines whether the elapsed time t3 is equal to or more than the threshold T32 and less than the threshold T33 (Step S1111). In a case where the elapsed time t3 is equal to or more than the threshold T32 and not less than the threshold T33 (Step S1111: No), the process moves to Step S1115. On the other hand, in a case where the elapsed time t3 is equal to or more than the threshold T32 and less than the threshold T33 (Step S1111: Yes), the action support device 100 determines whether a medicine is picked out of the pill case 107 by the subject (Step S1112).

In a case where a medicine is not picked out of the pill case 107 by the subject (Step S1112: No), the process returns to Step S1111. On the other hand, in a case where a medicine is picked out of the pill case 107 by the subject (Step S1112: Yes), the action support device 100 sets the user action evaluation 401 to “A3” as illustrated in FIG. 7 by the evaluation unit 601 (Step S1109).

Then, the action support device 100 selects the agent expression 402 corresponding to a combination of the user feeling 302 specified in Step S803 of FIG. 8 and the user action evaluation 401 set in Step S1113 with reference to the correspondence information 400 illustrated in FIG. 4 (Step S1114). Then, the process moves to Step S1106. With this configuration, the subject comes to execute the third task TK3.

In addition, in Step S1115, the action support device 100 determines whether a medicine is picked out of the pill case 107 by the subject (Step S1115). In a case where a medicine is picked out of the pill case 107 by the subject (Step S1115: Yes), the action support device 100 sets the user action evaluation 401 to “A2” as illustrated in FIG. 7 by the evaluation unit 601 (Step S1116).

Then, the action support device 100 selects the agent expression 402 corresponding to a combination of the user feeling 302 specified in Step S803 of FIG. 8 and the user action evaluation 401 set in Step S1116 with reference to the correspondence information 400 illustrated in FIG. 4 (Step S1117). Then, the process moves to Step S1106. With this configuration, the subject comes to execute the third task TK3.

On the other hand, in a case where a medicine is not picked out of the pill case 107 by the subject (Step S1115: No), the action support device 100 sets the user action evaluation 401 to “A1” as illustrated in FIG. 7 by the evaluation unit 601 (Step S1118). Then, the action support device 100 selects the agent expression 402 corresponding to a combination of the user feeling 302 specified in Step S803 of FIG. 8 and the user action evaluation 401 set in Step S1118 with reference to the correspondence information 400 illustrated in FIG. 4 (Step S1119).

Then, the action support device 100 outputs the selected agent expression 402 by the output unit 604 (Step S1120), and decreases the iteration i to return from the third task TK3 to the second task TK2 (Step S1121). In this case, the subject comes not to execute the third task TK3.

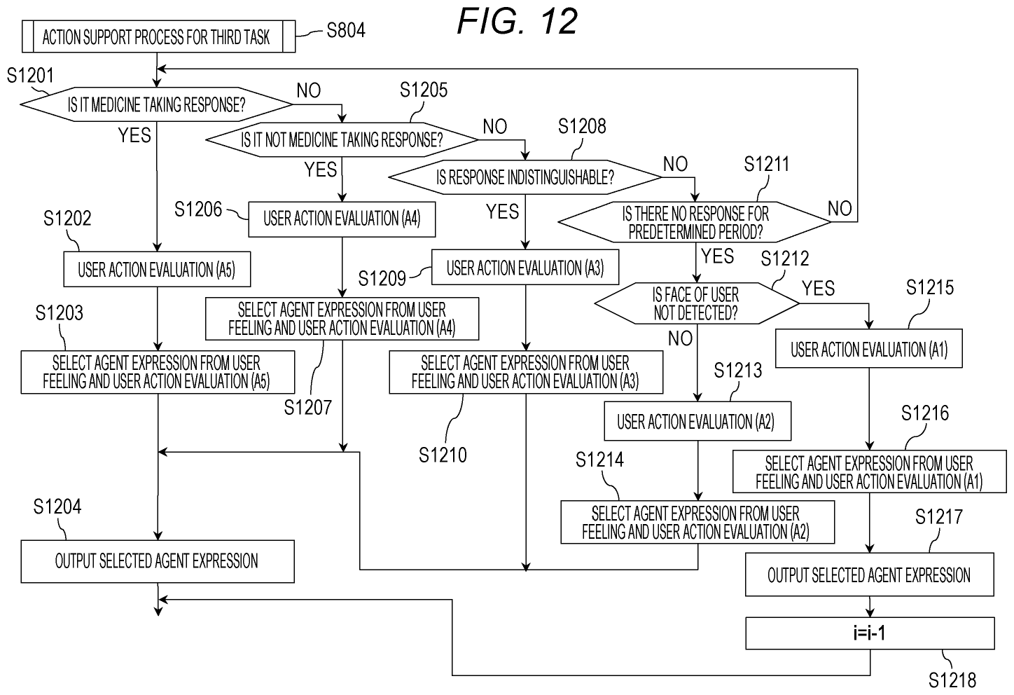

FIG. 12 is a flowchart illustrating a detailed exemplary action support processing procedure relating to the fourth task TK4 of the action support device 100 according to the first embodiment. The action support device 100 determines whether the analysis result of the voice input from the subject in the fourth task TK4 is a medicine taking response, from the subject, indicating that a medicine is taken (Step S1201). In a case where the response is not the medicine taking response (Step S1201: No), the process moves to Step S1205.

In a case where the response is the medicine taking response (Step S1201: Yes), the action support device 100 sets the user action evaluation 401 to “A5” as illustrated in FIG. 7 by the evaluation unit 601 (Step S1202). Then, the action support device 100 selects the agent expression 402 corresponding to a combination of the user feeling 302 specified in Step S803 of FIG. 8 and the user action evaluation 401 set in Step S1202 with reference to the correspondence information 400 illustrated in FIG. 4 (Step S1203). Then, the action support device 100 outputs the selected agent expression 402 by the output unit 604 (Step S1204). With this configuration, the subject comes to execute the fourth task.

In addition, in Step S1205, the action support device 100 determines whether the analysis result of the voice input from the subject is a no-medicine taking response indicating that the subject does not yet take a medicine (Step S1205). In a case where the response is not a no-medicine taking response (Step S1205: No), the process moves to Step S1208. On the other hand, in a case where the response is a no-medicine taking response (Step S1205: Yes), the action support device 100 sets the user action evaluation 401 to “A4” as illustrated in FIG. 7 by the evaluation unit 601 (Step S1206).

Then, the action support device 100 selects the agent expression 402 corresponding to a combination of the user feeling 302 specified in Step S803 of FIG. 8 and the user action evaluation 401 set in Step S1206 with reference to the correspondence information 400 illustrated in FIG. 4 (Step S1207). Then, the process moves to Step S1204. With this configuration, the subject comes to execute the fourth task TK4.

In addition, in Step S1208, the action support device 100 determines whether the analysis result of the voice input from the subject is an indistinguishable response (Step S1208). In a case where the response is not an indistinguishable response (Step S1208: No), the process moves to Step S1211. On the other hand, in a case where the response is an indistinguishable response (Step S1208: Yes), the action support device 100 sets the user action evaluation 401 to “A3” as illustrated in FIG. 7 by the evaluation unit 601 (Step S1209).

Then, the action support device 100 selects the agent expression 402 corresponding to a combination of the user feeling 302 specified in Step S803 of FIG. 8 and the user action evaluation 401 set in Step S1209 with reference to the correspondence information 400 illustrated in FIG. 4 (Step S1210). Then, the process moves to Step S1204. With this configuration, the subject comes to execute the fourth task TK4.

In addition, in Step S1211, the action support device 100 determines whether there is no response for a predetermined period of time (Step S1211). In a case where the predetermined period of time does not elapse (Step S1211: No), the process returns to Step S1201. On the other hand, in a case where there is no response for the predetermined period of time (Step S1211: Yes), the action support device 100 determines whether the face of the subject is not detected (Step S1212). In a case where the face of the subject is detected (Step S1212: No), the action support device 100 sets the user action evaluation 401 to “A2” as illustrated in FIG. 7 by the evaluation unit 601 (Step S1213).

Then, the action support device 100 selects the agent expression 402 corresponding to a combination of the user feeling 302 specified in Step S803 of FIG. 8 and the user action evaluation 401 set in Step S1213 with reference to the correspondence information 400 illustrated in FIG. 4 (Step S1214). Then, the process moves to Step S1204.

On the other hand, in a case where the face of the subject is not detected (Step S1212: Yes), the action support device 100 sets the user action evaluation 401 to “A1” as illustrated in FIG. 7 by the evaluation unit 601 (Step S1215). Then, the action support device 100 selects the agent expression 402 corresponding to a combination of the user feeling 302 specified in Step S803 of FIG. 8 and the user action evaluation 401 set in Step S1215 with reference to the correspondence information 400 illustrated in FIG. 4 (Step S1216).

Then, the action support device 100 outputs the selected agent expression 402 by the output unit 604 (Step S1217), and decreases the iteration i to return from the fourth task TK4 to the third task TK3 (Step S1218). In this case, the subject comes not to execute the fourth task TK4.

In this way, according to the first embodiment, the action support device 100 causes the agent to show one's feeling according to the user action evaluation 401 and the user feeling 302 in the execution situation of each task, and induces the user action to an appropriate way. In a case where the user action is appropriate, the subject acts actively. Therefore, the action support device 100 causes the agent to show a positive feeling such as enchanted, pleasure, and satisfaction to encourage the subject to have a positive feeling. With this configuration, it is possible to stimulate a subject's synchronism.

On the other hand, in a case where the user action is slightly not appropriate and the user feeling 302 is negative, the user acts passively. Therefore, the action support device 100 causes the agent to show a feeling to cheer up the subject, such as envy and expectation, such that the subject is urged to take an action. In a case where the user action is not appropriate or in the case of exception, it shows an unexpected action. Therefore, the action support device 100 can cause the agent to show a surprised expression, or a negative feeling such as worried, sad, and annoyed.

### Second Embodiment

A second embodiment is an example in which the agent expression 402 is changed according to a transition of the task. With this configuration, the agent expression 402 can be made different according to the transition of the task even in the case of the same task, the same user action, and the same user feeling 302. Therefore, it is possible to achieve a variety of the agent expressions 402. Further, the second embodiment will be described focusing on a difference from the first embodiment. The same configurations as those of the first embodiment will be attached with the same symbol, and the description thereof will be omitted.

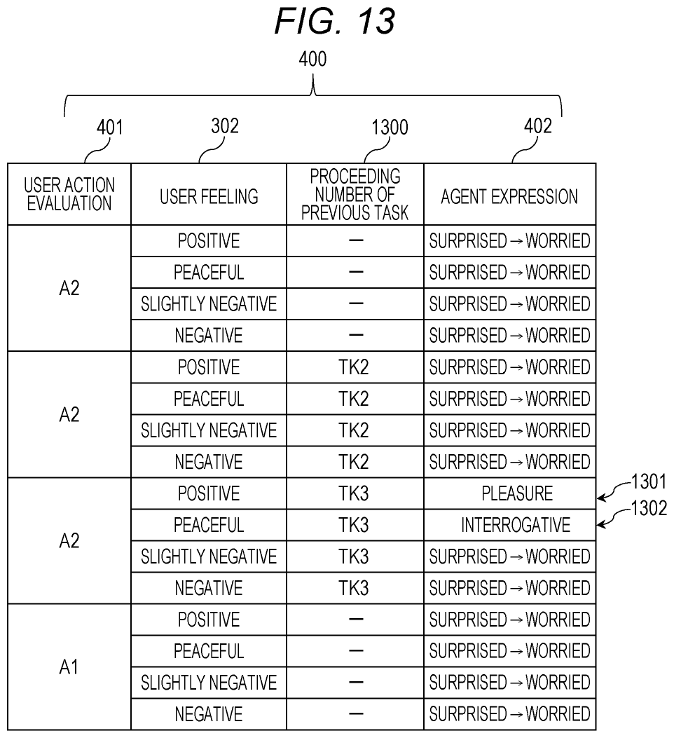

In the second embodiment, the select unit 603 selects the agent expression 402 on the basis of the user action evaluation 401, the user feeling 302 specified by the specify unit 602, the task at the transition destination by the subject (that is, the previous task) with reference to the correspondence information 400. A difference from the correspondence information 400 of FIG. 4 will be described using FIG. 13.

### Correspondence Information 400

FIG. 13 is a diagram for describing an example of the correspondence information 400 according to the second embodiment. The correspondence information 400 is a table in which the user action evaluation 401, the user feeling 302, the agent expression 402, and a proceeding number 1300 of the previous task are associated. The proceeding number 1300 of the previous task is identification information to uniquely specify the previous task. The previous task is a task which is executed right before the task currently being executed. Further, the entry of which the proceeding number 1300 of the previous task is “−” indicates that there is no previous task (that is, the current task is the first task TK1).

In addition, FIG. 13 is focused on a case where the user action is A2 and A1 for the convenience of explanation. However, the entry of A5 to A3 may exist. In addition, in FIG. 13, while the task is not specified, the entry value may differ for each task even though the correspondence information 400 is common to all the tasks.

In the first embodiment (FIG. 4), even if the user feeling 302 is any one of “positive”, “peaceful”, “slightly negative”, and “negative”, the agent expression 402 shows “surprised→worried” (the agent expression 402 changing from a surprised face image to a worried face image) as long as the user action is “A2”. With this regard, the previous task is considered in the second embodiment (FIG. 13). Therefore, in a case where the previous task number is “TK3”, the agent expression 402 is different from “surprised→worried”.

For example, in the case of the entry 1301, if the user action is “A2”, the user feeling 302 is “positive”, and the proceeding number 1300 of the previous task is “TK3” (that is, during the execution of the current fourth task TK4), the agent expression 402 becomes “pleasure” instead of “surprised→worried”. In addition, in the case of the entry 1302, if the user action is “A2”, the user feeling 302 is “peaceful”, and the proceeding number 1300 of the previous task is “TK3” (that is, during the execution of the current fourth task TK4), the agent expression 402 becomes “interrogative” instead of “surprised→worried”. In this way, since the transition of the task is considered, the variety of the agent expressions 402 can be achieved compared to the first embodiment.

Further, the process of selecting the agent expression 402 using the correspondence information 400 of FIG. 13 by the select unit 603 is performed in Steps S905, S911, S914, S918, and S920, Steps S1005, S1010, S1014, S1017, and S1019, Steps S1105, S1110, S1114, S1117, and S1119, and Steps S1203, S1207, S1210, S1214, and S1216 of FIGS. 9 to 12.

### Third Embodiment

A third embodiment is an example of changing the agent expression 402 according to a progressing situation of the task. With this configuration, the agent expression 402 can be made different according to the progressing situation of the task even in the case of the same task, the same user action, and the same user feeling 302. Therefore, it is possible to achieve a variety of the agent expressions 402. Further, the third embodiment will be described focusing on a difference from the first embodiment. The same configurations as those of the first embodiment will be attached with the same symbol, and the description thereof will be omitted.

In the third embodiment, the select unit 603 selects the agent expression 402 on the basis of the user action evaluation 401, the user feeling 302 specified by the specify unit 602, and the progressing situation of a series of tasks by the subject with reference to the correspondence information 400. A series of tasks is the first task TK1 to the fourth task TK4. An index value of the progressing situation is defined by the following Expression (1) for example.

Index value of Progressing Situation =(Elapsed time/Ideal Time+Transition Times/Ideal Transition Times)/2 . . . (1)

In Expression (1), the elapsed time on the right side is a time elapsed until the current time from the first task TK1. The ideal time is an ideal elapsed time up to the task currently being executed, and set in advance. The transition times is the number of times of transitioning the tasks until the current time. For example, in a case where the first task TK1→the second task TK2→the third task TK3 are transitioned, the transition times is “2” because the first task TK1 and the second task TK2 elapse. The ideal transition times is the number of times of transitions of the tasks in the elapsed time, and set in advance.

The index value of the progressing situation has a reference value of “1”. As the index value becomes smaller than 1, it indicates that the progressing situation is good. As the index value becomes larger than 1, it indicates that the progressing situation is bad. The select unit 603 calculates the index value of the progressing situation using Expression (1), and selects the agent expression 402 using the following correspondence information 400.

### Correspondence Information 400

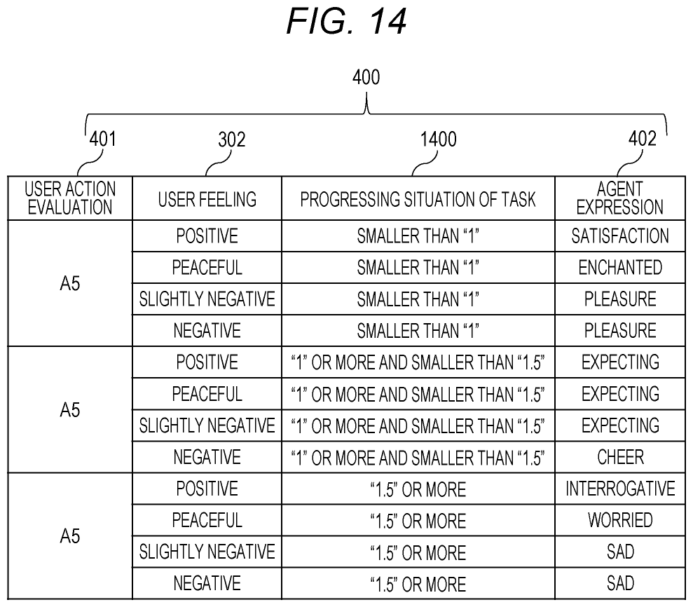

FIG. 14 is a diagram for describing an example of the correspondence information 400 according to the third embodiment. The correspondence information 400 is a table in which the user action evaluation 401, the user feeling 302, the agent expression 402, and a progressing situation 1400 of the task are associated. FIG. 14 is focused on a case where the user action is A5 for the convenience of explanation. However, the entry of A4 to A1 may exist. In addition, in FIG. 14, while the task is not specified, the entry value may differ for each task even though the correspondence information 400 is common to all the tasks.

The progressing situation 1400 of the task defines an application range of the index value of the progressing situation. In the first embodiment (FIG. 4), if he user action is “A5”, the agent expression 402 is “satisfaction”, “enchanted”, “pleasure”, and “pleasure” in an order of “positive”, “peaceful”, “slightly negative”, and “negative” of the user feeling 302. With this regard, the index value of the progressing situation is considered in the third embodiment (FIG. 14). Therefore, in a case where the index value of the progressing situation is smaller than 1, the expression is the same as the agent expression 402 of the first embodiment (FIG. 4). However, in a case where the index value is equal to or more than 1, the expression becomes different from the agent expression 402 of the first embodiment (FIG. 4).

For example, if the index value of the progressing situation is equal to or more than 1 and less than 1.5, the agent expression 402 becomes “expecting”, “expecting”, “expecting”, and “cheer” in an order of “positive”, “peaceful”, “slightly negative”, and “negative” of the user feeling 302. In addition, if the index value of the progressing situation is equal to or more than 1.5, the agent expression 402 becomes “interrogative”, “worried”, “sad”, and “sad” in an order of “positive”, “peaceful”, “slightly negative”, and “negative” of the user feeling 302. In this way, since the progressing situation 1400 of the task is considered, the variety of the agent expressions 402 can be achieved compared to the first embodiment.

Further the process of calculating the index value of the progressing situation and the process of selecting the agent expression 402 using the correspondence information 400 of FIG. 14 by the select unit 603 are performed in Steps S905, S911, S914, S918, S920, Steps S1005, S1010, S1014, S1017, S1019, Steps S1105, S1110, S1114, S1117, and S1119, Steps S1203, S1207, S1210, S1214, and S1216 of FIGS. 9 to 12.

### Fourth Embodiment

A fourth embodiment is an example in which the agent expression 402 to the subject is changed on the basis of a past history, and learns the agent expression 402 at which the subject is easy to act appropriately. With this configuration, it is possible to induce an appropriate action of the subject with more efficiency. Further, the fourth embodiment will be described focusing on a difference from the first embodiment. The same configurations as those of the first embodiment will be attached with the same symbol, and the description thereof will be omitted.

### Correspondence Information 400

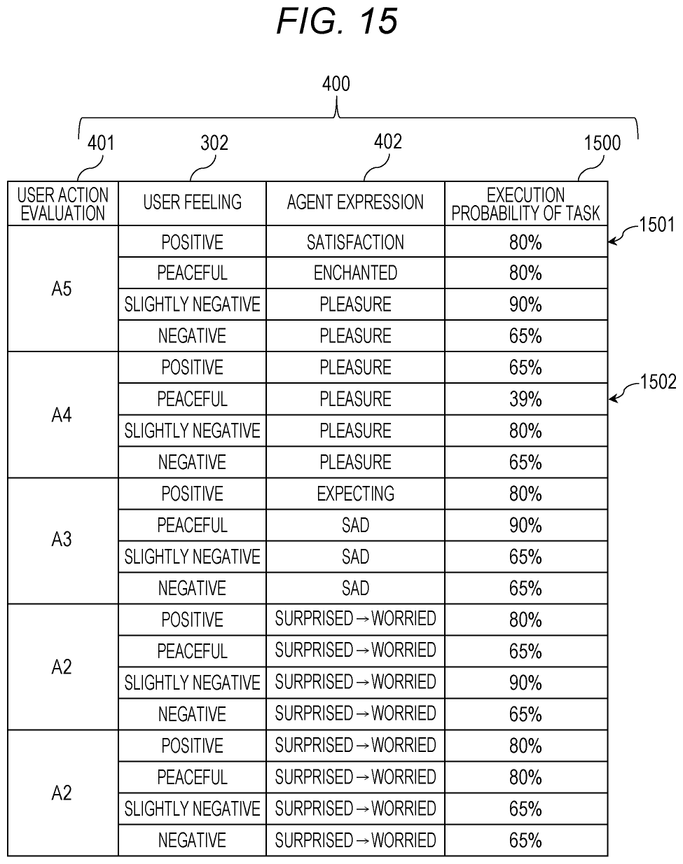

FIG. 15 is a diagram for describing an example of the correspondence information 400 according to the fourth embodiment. The correspondence information 400 is a table in which the user action evaluation 401, the user feeling 302, the agent expression 402, and an execution probability 1500 of the task are associated. In FIG. 15, while the task is not specified, the entry value may differ for each task even though the correspondence information 400 is common to all the tasks.

The execution probability 1500 of the task is a probability that the task is executed. The execution probability 1500 of the task is updated in a unit of entry whenever the agent expression 402 is output with respect to the task. For example, in a case where “satisfaction” of the agent expression 402 of the entry 1501 is output in the task currently being executed, the execution probability 1500 of the task is updated from 80%.

### Exemplary Functional Configuration of Action Support Device 100

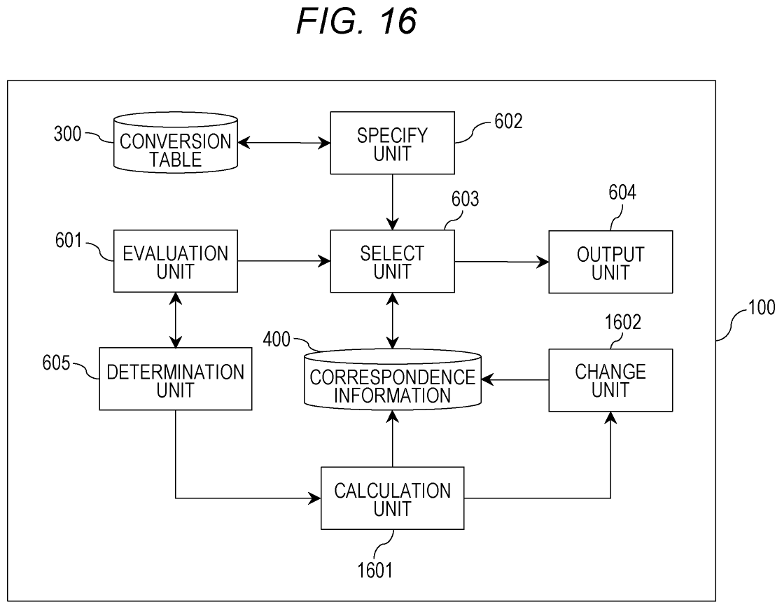

FIG. 16 is a block diagram illustrating an exemplary functional configuration of the action support device 100 according to the fourth embodiment. The action support device 100 includes a calculation unit 1601 and a change unit 1602 besides the evaluation unit 601, the specify unit 602, the select unit 603, the output unit 604, the determination unit 605, the conversion table 300, and the correspondence information 400. Specifically, the calculation unit 1601 and the change unit 1602 are realized by causing the processor 201 to perform a program stored in the memory device 202 illustrated in FIG. 2, for example.

The calculation unit 1601 accumulates a determination result of the determination unit 605, and calculates the execution probability 1500 of the task on the basis of the accumulated determination result. The determination result of the determination unit 605 indicates whether the task is successively executed as described in the first embodiment. The calculation unit 1601 accumulates the number of times of successes and the number of times of outputting the agent expression 402 for each task as the determination result.

Specifically, for example, the calculation unit 1601 accumulates the number of times of successes and the number of times of outputting the agent expression 402 for each combination of the user action and the user feeling 302 which are bases of the determination result with respect to each task. The calculation unit 1601 calculates the execution probability 1500 of the task by dividing the number of times of successes by the number of times of outputting the agent expression 402 for each task. The calculation unit 1601 updates the calculated execution probability 1500 of the task to the correspondence information 400.

The change unit 1602 changes the agent expression 402 in the correspondence information 400 on the basis of the calculation result of the calculation unit 1601. Specifically, for example, in a case where the execution probability 1500 of the task is equal to or less than a predetermined threshold, the change unit 1602 updates the agent expression 402 corresponding to the execution probability to the agent expression 402 at which the subject easily executes the task. The agent expression 402 to be changed may be set in advance.

For example, the threshold is set to 40%. In the case of the entry 1502, the updated execution probability 1500 of the task is 39%. Therefore, the change unit 1602 changes the agent expression 402 to other agent expression 402 from “pleasure”. Specifically, for example, the change unit 1602 changes the agent expression to “enchanted” of the agent expression 402 corresponding to the positive user feeling 302 rather than “pleasure”. In addition, the change unit 1602 may change the agent expression to other agent expression 402 of which the execution probability 1500 of the task is higher than the agent expression 402 in the user action.

### Exemplary Action Support Processing Procedure

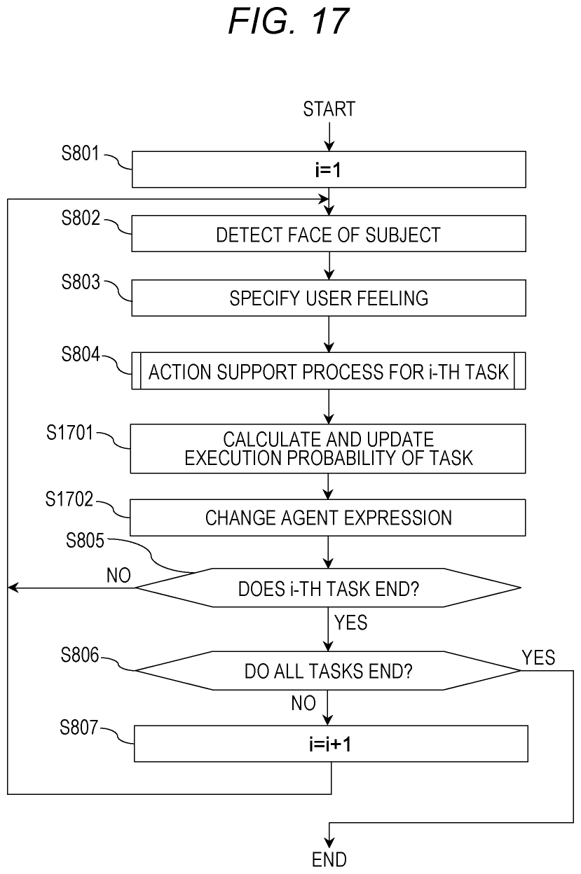

FIG. 17 is a flowchart illustrating an exemplary action support processing procedure of the action support device 100 according to the fourth embodiment. After performing the action support process (Step S804) related to the i-th task TKi, the action support device 100 counts the number of times of successes of the task execution and the number of times of outputting the selected agent expression 402 for each user action evaluation 401 by the calculation unit 1601 in the i-th task TKi, and calculates the execution probability 1500 of the task.

Then, the action support device 100 updates the calculated execution probability 1500 of the task to the correspondence information 400 by the calculation unit 1601 (Step S1701). Then, the action support device 100 changes the agent expression 402 at which the updated execution probability 1500 of the task in Step S1701 becomes equal to or less than a predetermined threshold to the other agent expression 402 by the change unit 1602 (Step S1702), and the process moves to Step S805.

With this configuration, the action support device 100 can learn the agent expression 402 at which the subject is easy to act appropriately. It is possible to induce an appropriate action of the subject with more efficiency.

Further, in the first to fourth embodiments, the medication device has been described as an example of the action support device 100, but the invention is not limited to the medication device. For example, the action support device 100 may be a learning support device which supports a student as the subject in an education field, or may be a care support device which cares a person who needs care as the subject in a nursing field. In these cases, the content of the task is set according to the content of the learning support and the nursing support.

Further, the invention is not limited to the above-described embodiments. Various modifications and equivalent configurations may be contained within the scope of claims. For example, the above-described embodiments are given in detail in order to help easy understating of the invention. The invention is not limited to be provided all the configurations described above. In addition, some of the configurations of a certain embodiment may be replaced with the configuration of the other embodiment. In addition, the configurations of the other embodiment may be added to the configurations of a certain embodiment. In addition, some of the configurations of each embodiment may be added, omitted, or replaced with respect to the configuration of the other embodiment.

In addition, the above-described configurations, processing units, and processing means may be realized by a hardware configuration by setting some or all of the configurations using an integrated circuit, or may be realized by a software configuration by analyzing and performing a program to realize the functions by the processor.

The information of the program realizing functions, tables, and files may be stored in a memory device such as a memory, a hard disk, a Solid State Drive (SSD) or a recording medium such as an Integrated Circuit (IC) card, an SD card, and a Digital Versatile Disc (DVD).

In addition, only control lines and information lines considered to be necessary for explanation are illustrated, but not all the control lines and the information lines necessary for mounting are illustrated.

In practice, almost all the configurations may be considered to be connected to each other.

What is claimed is:

1. An action support device, comprising:
a processor which performs a program;
a memory device which stores the program;
an acquisition device which acquires information related to a subject; and
an output device which outputs information to the subject,
wherein the memory device stores correspondence information in which an action and a feeling of the subject and an expression of a face image output from the output device are associated with respect to each of a series of tasks set in order, and
wherein the processor performs
a specification process in which a feeling of the subject is specified on the basis of the information related to an expression of the subject acquired by the acquisition device,
an evaluation process in which an action related to the task of the subject is evaluated on the basis of the information related to a behavior of the subject acquired by the acquisition device,
a selection process in which an expression of the face image is selected with reference to the correspondence information on the basis of the feeling of the subject specified by the specification process and an evaluation result of the evaluation process, and
an output process in which the face image of the expression selected by the selection process is output by the output device.

2. The action support device according to claim 1,
wherein the processor performs a determination process to determine whether the task is performed successfully on the basis of the evaluation result of the action related to the task obtained in the evaluation process in a case where information indicating a feeling of the action support device is output by the output process,
wherein the processor specifies again the feeling of the subject on the basis of the information related to the expression of the subject acquired by the acquisition device in the specification process in a case where it is determined that the execution of the task is successful in the determination process, and
wherein the processor evaluates again the action related to a next task of the subject on the basis of information related to the behavior of the subject in the evaluation process in a case where it is determined that the execution of the task is successful in the determination process.

3. The action support device according to claim 1,
wherein the processor selects an expression of the face image with reference to the correspondence information on the basis of the evaluation result, the feeling of the subject specified in the specification process, and a task at a transition destination of the task by the subject in the selection process.

4. The action support device according to claim 1,
wherein the processor selects an expression of the face image with reference to the correspondence information on the basis of the evaluation result, the feeling of the subject specified in the specification process, and a progressing situation the series of tasks by the subject in the selection process.

5. The action support device according to claim 2,
wherein the processor is configured to perform
a calculation process in which a determination result of the determination process is accumulated and an execution probability of the task is calculated on the basis of the accumulated determination result, and
a change process in which the expression of the face image in the correspondence information is changed on the basis of a calculation result of the calculation process.

6. The action support device according to claim 5,
wherein, in the calculation process, the processor accumulates the determination result of the determination process for each combination of the action and the feeling of the subject and the expression of the face image which are based on the determination result, and calculates a progressing result of the task with respect to the accumulated determination result in the combination on the basis of the accumulated determination result in the combination, and
wherein, in the change process, the processor changes the expression of the face image in the combination in the correspondence information.

7. An action support method of an action support device,
the action support device including:
a processor which performs a program;
a memory device which stores the program;
an acquisition device which acquires information related to a subject; and
an output device which outputs information to the subject,
wherein the memory device stores correspondence information in which an action and a feeling of the subject and an expression of a face image output from the output device are associated with respect to each of a series of tasks set in order,
wherein the processor performs
a specification process in which a feeling of the subject is specified on the basis of the information related to an expression of the subject acquired by the acquisition device,
an evaluation process in which an action related to the task of the subject is evaluated on the basis of the information related to a behavior of the subject acquired by the acquisition device,
a selection process in which an expression of the face image is selected with reference to the correspondence information on the basis of the feeling of the subject specified by the specification process and an evaluation result of the evaluation process, and
an output process in which the face image of the expression selected by the selection process is output by the output device.

8. The action support method according to claim 7,
wherein the processor performs a determination process to determine whether the task is performed successfully on the basis of the evaluation result of the action related to the task obtained in the evaluation process in a case where information indicating a feeling of the action support device is output by the output process,
wherein the processor specifies again the feeling of the subject on the basis of the information related to the expression of the subject acquired by the acquisition device in the specification process in a case where it is determined that the execution of the task is successful in the determination process, and
wherein the processor evaluates again the action related to a next task of the subject on the basis of information related to the behavior of the subject in the evaluation process in a case where it is determined that the execution of the task is successful in the determination process.

9. The action support method according to claim 7,
wherein the processor selects an expression of the face image with reference to the correspondence information on the basis of the evaluation result, the feeling of the subject specified in the specification process, and a task at a transition destination of the task by the subject in the selection process.

10. The action support method according to claim 7,
wherein the processor selects an expression of the face image with reference to the correspondence information on the basis of the evaluation result, the feeling of the subject specified in the specification process, and a progressing situation a series of tasks by the subject in the selection process.

11. The action support method according to claim 8,
wherein the processor is configured to perform
a calculation process in which a determination result of the determination process is accumulated and an execution probability of the task is calculated on the basis of the accumulated determination result, and
a change process in which the expression of the face image in the correspondence information is changed on the basis of a calculation result of the calculation process.

12. The action support method according to claim 11,
wherein, in the calculation process, the processor accumulates the determination result of the determination process for each combination of the action and the feeling of the subject and the expression of the face image which are based on the determination result, and calculates a progressing result of the task with respect to the accumulated determination result in the combination on the basis of the accumulated determination result in the combination, and
wherein, in the change process, the processor changes the expression of the face image in the combination in the correspondence information.
